(19) United States
(12) Patent Application Publication
(10) Pub. No.: US 2017/0315062 A1
(43) Pub. Date: Nov. 2, 2017

(54) INSPECTION APPARATUS, INSPECTION SYSTEM, AND ARTICLE MANUFACTURING METHOD

(71) Applicant: CANON KABUSHIKI KAISHA, Tokyo (JP)

(72) Inventors: Hideki Matsuda, Kawachi-gun (JP); Takanori Uemura, Saitama-shi (JP)

(21) Appl. No.: 15/495,666

(22) Filed: Apr. 24, 2017

(30) Foreign Application Priority Data
Apr. 28, 2016 (JP) 2016-091584

(51) Int. Cl. G01N 21/88

(52) U.S. Cl. CPC G01N 21/8806; G01N 21/8851; G01N 2021/8845; G01N 2021/8822

(57) ABSTRACT

An inspection apparatus for performing inspection of an object includes an illumination device configured to illuminate the object, an imaging device configured to image the object illuminated by the illumination device, and a processor configured to perform processing for the inspection based on an image obtained by the imaging device. The processor is configured to perform the processing based on a first image obtained by the imaging device under dark field illumination by the illumination device with light having a first wavelength and a second image obtained by the imaging device under dark field illumination by the illumination device with light having a second wavelength different from the first wavelength.

### BACKGROUND

### Field of Art

The present disclosure relates to an inspection apparatus for performing inspection of an object, an inspection system, and an article manufacturing method.

### Description of the Related Art

For inspection of an object (e.g., a work) for, for example, appearance, inspection apparatuses for inspecting an object based on an image obtained by imaging the object illuminated with light have been increasingly used instead of visual inspection apparatuses. These inspection apparatuses include an inspection apparatus for inspecting an object for a color defect as well as height unevenness (concavity and convexity) of the surface of the object (Japanese Patent No. 5470708). The inspection apparatus disclosed in Japanese Patent No. 5470708 detects height unevenness of an object based on regularly reflected light (specularly reflected light) from the object and detects a defect associated with color irregularity based on diffusely reflected light from the object.

Although the inspection apparatus disclosed in Japanese Patent No. 5470708 detects color irregularity based on diffusely reflected light from the object, wavelengths of illumination light are not adequately taken into account for inspection of an object regarding color thereof.

### SUMMARY

The present disclosure provides, for example, an inspection apparatus advantageous in inspection of an object regarding color thereof.

An aspect of the present disclosure provides an inspection apparatus for performing inspection of an object. The apparatus includes an illumination device configured to illuminate the object, an imaging device configured to image the object illuminated by the illumination device, and a processor configured to perform processing for the inspection based on an image obtained by the imaging device. The processor is configured to perform the processing based on a first image obtained by the imaging device under dark field illumination by the illumination device with light having a first wavelength and a second image obtained by the imaging device under dark field illumination by the illumination device with light having a second wavelength different from the first wavelength.

Features of the present invention will become apparent from the following description of exemplary embodiments with reference to the attached drawings.

### BRIEF DESCRIPTION OF THE DRAWINGS

FIG. 1 is a diagram illustrating an exemplary configuration of an inspection apparatus according to a first embodiment.

FIG. 2 is a diagram illustrating an exemplary configuration of an illumination device.

FIG. 3 is a diagram illustrating the exemplary configuration of the illumination device.

FIG. 4 is a graph illustrating a threshold for a color defect.

FIG. 5 is a diagram illustrating an exemplary configuration of an illumination device of an inspection apparatus according to a second embodiment.

FIG. 6 is a diagram illustrating an exemplary configuration of an inspection apparatus according to a third embodiment.

### DESCRIPTION OF THE EMBODIMENTS

Embodiments will be described with reference to the accompanying drawings. In the figures illustrating the embodiments, in principle (unless otherwise noted), the same components are designated by the same reference numerals and redundant description is avoided.

### First Embodiment

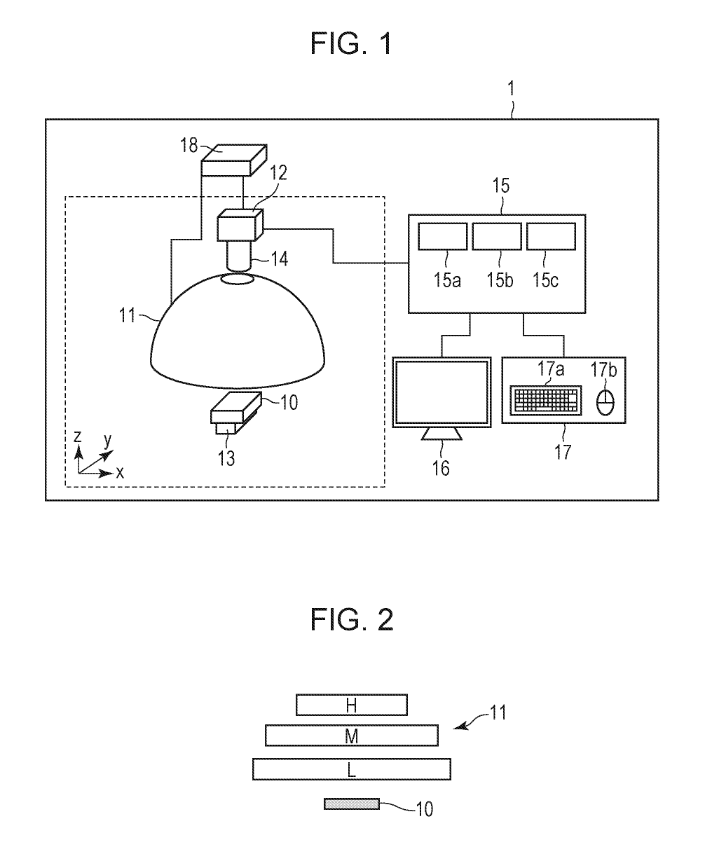

FIG. 1 is a diagram illustrating an exemplary configuration of an inspection apparatus according to a first embodiment. In FIG. 1, an inspection apparatus 1 inspects a target (object), such as a work 10, for appearance. Examples of the work 10 include a metal member and a resin member to be used in industrial products. The surface of the work 10 may have a defect, such as a flaw, irregularity (e.g., color irregularity), or height unevenness. The inspection apparatus 1 detects a defect based on an image obtained by imaging the work 10 and classifies (sorts) the work as, for example, either non-defective or defective.

The inspection apparatus 1 includes an illumination device 11, an imaging device including a camera 12 and an optical system 14, a controller 18, a processor 15, a display unit 16, and an input unit 17. The inspection apparatus 1 may further include a holder 13 for holding the work 10. The work 10 is carried to a predetermined position relative to the inspection apparatus 1 by a transport unit (not illustrated), such as a conveyor 1012 in FIG. 6. After inspection, the work 10 is carried away from the predetermined position by the transport unit.

The illumination device 11 illuminates the work 10. The imaging device (including the camera 12 and the optical system 14) images the work 10 illuminated by the illumination device 11 to obtain an image. The image of the work 10 obtained by the imaging device is transferred to the processor 15. The processor 15 may include an information processing apparatus including a central processing unit (CPU) 15a, a random access memory (RAM) 15b, and a hard disk drive (HDD) 15c. The processor 15 can obtain an evaluation value with respect to a target image obtained (transferred) and execute a process (classification process) of classifying the work as non-defective or defective based on the evaluation value and a threshold (allowable range). For example, the CPU 15a executes a program for the classification process and the RAM 15b and the HDD 15c store the program and data. The display unit 16 includes a TV monitor and displays a result of processing performed by the processor 15. The input unit 17 includes a keyboard 17a and a mouse 17b and allows data or an instruction to input to the controller 18 or the processor 15 in response to, for example, a user operation. The controller 18 and the processor 15 may be configured as a common information processing unit.

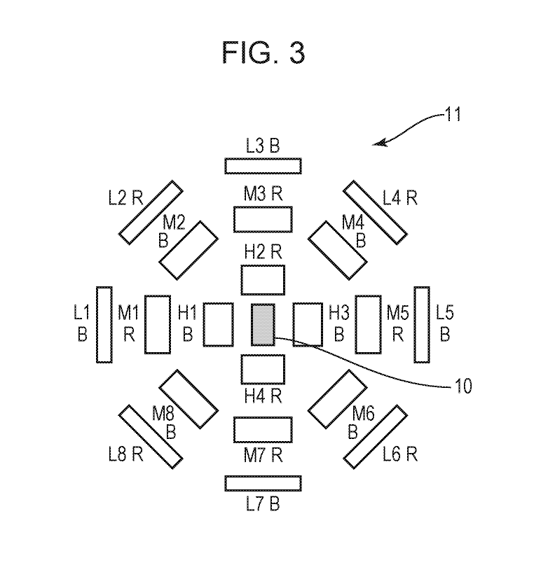

The illumination device 11 will now be described in detail. The illumination device 11 includes a plurality of light emitters (light sources). With this configuration, the illumination device 11 can illuminate the work 10 selectively from various directions (each direction is defined as a combination of an elevation angle and an azimuth angle). Locations of the light emitters in the illumination device 11 will be described with reference to FIGS. 2 and 3. FIGS. 2 and 3 each illustrate an exemplary configuration of the illumination device 11. FIG. 2 illustrates the locations of the light emitters when the illumination device 11 is viewed in the y direction in FIG. 1. FIG. 3 illustrates the locations of the light emitters when the illumination device 11 is viewed in the z direction in FIG. 1. FIG. 2 illustrates the locations of the light emitters in terms of the elevation angle of the direction of illumination light. In the present embodiment, the light emitters are divided into three groups in terms of the elevation angle. Specifically, the light emitters are divided into a group L at a relatively low elevation angle (low angle), a group H at a relatively high elevation angle (high angle), and a group M at a middle elevation angle (middle angle) between the relatively high and low elevation angles. FIG. 3 illustrates the locations of the light emitters in terms of the azimuth angle of the direction of illumination light. In the present embodiment, light emitters L1 to L8 of the group L are arranged at eight azimuth angles. Furthermore, light emitters M1 to M8 of the group M are similarly arranged at eight azimuth angles. In addition, light emitters H1 to H4 of the group H are arranged at four azimuth angles. As illustrated in FIGS. 2 and 3, the light emitters of the illumination device 11 are arranged in the form of a dome. The light emitters illuminate the work 10, which is positioned under the dome as illustrated in FIG. 2 such that the work 10 is positioned at the center of the dome as illustrated in FIG. 3. The kinds of elevation angles and those of azimuth angles of illumination by the light emitters, the kinds of colors (wavelengths) of light emitted by the light emitters, and the kinds of illumination and imaging modes are not limited to those described above and later and may be changed as appropriate.

As illustrated in FIG. 3, the plurality of light emitters include light emitters emitting light having wavelengths corresponding to blue and light emitters emitting light having wavelengths corresponding to red. In FIG. 3, the light emitters indicated by B emit blue light and the light emitters indicated by R emit red light. In this case, each light emitter may be, for example, a light emitting device, such as a light emitting diode (LED). Light having wavelengths corresponding to blue is, for example, light having a center wavelength of approximately 450 nm. Light having wavelengths corresponding to red is, for example, light having a center wavelength of approximately 650 nm. A center wavelength of a light emitting device may be considered as the wavelength of the light emitting device.

The light emitters L1 to L8 are arranged such that the light emitters at opposite azimuth angles emit the same color light. This arrangement is intended to provide an illuminance distribution on a work, illuminated with the same color light, as uniformly as possible under both an illumination condition where all of the light emitters L1, L3, L5, and L7 are caused to emit light and an illumination condition where all of the light emitters L2, L4, L6, and L8 are caused to emit light. The uniformity is effective in detecting a color defect of the entire work as will be described later. Furthermore, the light emitters M1 to M8 differ from the light emitters L1 to L8 in arrangement of blue and red colors at the azimuth angles. This arrangement is intended to illuminate a work from different azimuth angles when all of the blue light emitters at all of the elevation angles are caused to emit light, thus reducing noise caused by, for example, a specific flaw. Consequently, a defect, such as color irregularity, of the work can be detected at a high signal to noise (S/N) ratio as will be described later.

For inspection of the work 10, the controller 18 can implement the following three modes (modes 1 to 3) for illumination and imaging.

Mode 1: the light emitters sequentially illuminate an object and the object is imaged in synchronism with the timing of illumination.

Mode 2: imaging is performed under dark field illumination with all of the light emitters L1, L3, L5, and L7 emitting blue light and imaging is performed under dark field illumination with all of the light emitters L2, L4, L6, and L8 emitting red light. The illumination device includes the plurality of light emitters (light sources) for illuminating an object from a plurality of azimuth angles at a specific elevation angle (in this case, the low angle for dark field illumination). The light sources emit blue light (having a first wavelength) and the light sources emit red light (having a second wavelength) are alternately arranged.

Mode 3: imaging is performed under illumination with all of the light emitters L1, L3, L5, L7, M2, M4, M6, M8, H1, and H3 emitting blue light.

A process for inspection (defect detection) based on images obtained by imaging under illumination in the will now be described. This process is performed by the processor 15. Images obtained in the mode 1 are used to detect a defect mainly caused by an abnormal condition of a surface, for example, a flaw, a foreign substance, or height unevenness of the surface of the work 10. In this case, image synthesis can be used to obtain a relatively high S/N ratio. The image synthesis can be performed by obtaining, for example, a representative value (e.g., the difference between a maximum value and a minimum value) for each pixel. Images obtained in the mode 2 are used to detect a defect (defective or abnormality) of the (overall) color appearance of the work. In this case, a representative value (e.g., an average value) of pixel values of a first image obtained with the blue (first wavelength) light is obtained. Similarly, a representative value (e.g., an average value) of pixel values of a second image obtained with the red (second wavelength) light is obtained. The ratio of the representative values is obtained. If the ratio exceeds a predetermined threshold (allowable range), the work can be determined to have a color defect.

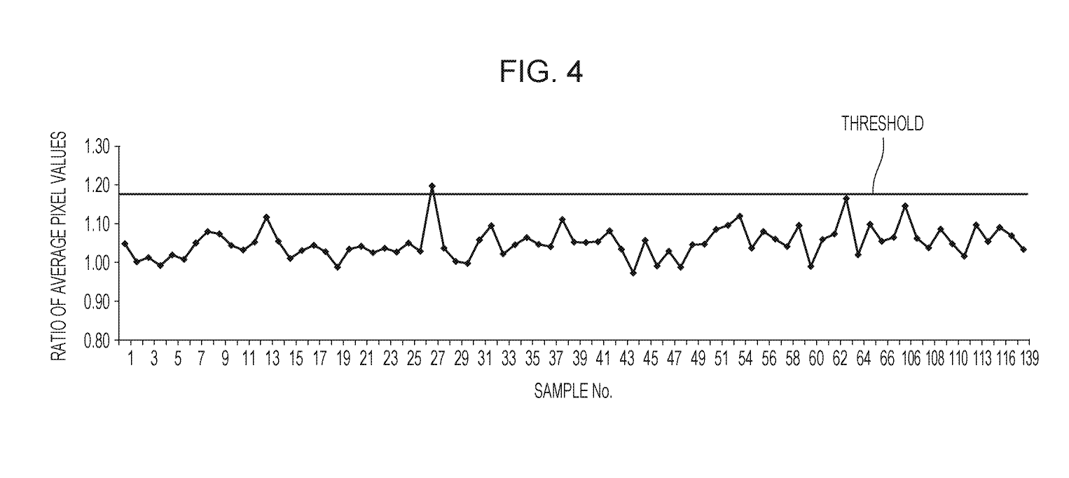

FIG. 4 is a graph illustrating a threshold for a color defect. FIG. 4 illustrates the above-described ratios (in this case, the ratio of average values or average pixel values) associated with 139 works. In FIG. 4, the horizontal axis represents the sample number assigned to a work and the vertical axis represents the ratio ([the average value of pixel values of the first image obtained with the blue (first wavelength) light] divided by [the average value of pixel values of the second image obtained with the red (second wavelength) light]) associated with the work. Referring to FIG. 4, the ratio associated with a work assigned the sample number 27 is considerably greater than the ratios associated with the other works and exceeds the predetermined threshold. Thus, the work assigned the sample number 27 is determined to have a color defect. The threshold (allowable range) may be learned in advance and be stored in the processor 15 (e.g., the HDD 15c). If single-color illumination is used to detect a color defect of a work, a change in representative value (e.g., average value) described above would occur due to a difference in color of the work. Such a change in representative value would also occur due to a difference in surface roughness of the surface of the work. With only single-color illumination, the difference in color (defect) could not be distinguished from the difference in surface roughness (defect). For this reason, the above-described ratio is obtained by using illumination conditions of multiple colors, so that a color defect can be detected. A difference in color (defect) can be detected with high sensitivity by using dark field illumination, because inner part of a work generally or typically contains more coloring matter than the surface of the work. Under bright field illumination (specularly reflected light), the coloring matter affects a relatively small number of components of reflected light. In contrast, under dark field illumination (diffusely reflected light), the coloring matter affects a relatively large number of components of reflected light. An image obtained in the mode 3 is used to detect, as a defect, color irregularity of a work. In the present embodiment, color irregularity is detected as a defect based on an image obtained under illumination with all of the blue light emitters L1, L3, L5, L7, M2, M4, M6, M8, H1, and H3.

In the present embodiment, the work 10 is illuminated with blue light and red light in the mode 2 and is illuminated with blue light in the mode 3. The color of illumination light may be determined depending on the color of the work 10 so that a color defect can be detected with high sensitivity. A way to select the color (wavelength) of illumination light will now be described. The color of illumination light with which a difference in color (defect) of a work can be detected with high sensitivity is the color of the work and a complementary color of the color of the work. For example, it is assumed that illumination is performed with light of the same color as that of a work. When the work is pale in color, an obtained image is dark, that is, pixel values are low. When the work is deep in color, an obtained image is bright, that is, pixel values are high. The relationship between the intensity of the color of the work and the pixel values is opposite to that obtained when illumination is performed with light of the complementary color of the color of the work. For a color other than the color of the work and the complementary color thereof, the rate of change in pixel values relative to a change in intensity of the color of the work is low. Obtaining two images with the above-described two illumination light colors provides a large difference in pixel values between the images. This is effective in detecting a difference in color (defect) of the work. Specifically, one of the first and second wavelengths can correspond to one of a color of an object and a complementary color thereof. The other of the first and second wavelengths can correspond to the other of the color of the object and the complementary color thereof. Obtaining an image with illumination light of either the color of the work or the complementary color thereof is effective in detecting color irregularity (defect) of the work.

For example, if the work is yellow, the color (yellow) of the work and blue as a complementary color of yellow can be selected. Considering that LEDs of three colors, red, blue, and green, are generally readily available, blue may be used as a first color and red having wavelengths close to those of yellow and significantly different from those of blue may be used as a second color. A work color suitable for illumination with blue light and red light is a color based on yellow, blue, or green. Furthermore, a work color suitable for illumination with green light and red light is a color based on red or green, and a work color suitable for illumination with green light and blue light is a color based on red or yellow. Light having wavelengths corresponding to green has a center wavelength of approximately 550 nm.

In the present embodiment, the camera 12 may be a monochrome camera typically having a relatively high resolution. A color camera typically having a relatively low resolution may be used if the resolution is acceptable. In this case, in the mode 2, the illumination device can illuminate a work with light having a first wavelength and light having a second wavelength, which may be white light. The imaging device can obtain a first image corresponding to the first wavelength and a second image corresponding to the second wavelength. In the mode 3, the illumination device can illuminate a work with light having a first wavelength and light, which may be white light, having a second wavelength different from the first wavelength. The imaging device can obtain an image corresponding to the first wavelength. The imaging device may include a color separation optical system and a plurality of image pickup elements or may include a single image pickup element including a color filter.

In the mode 2, two pairs of opposed light emitters (e.g., the light emitters L1 and L5 and the light emitters L3 and L7) are used for each color. If the illuminance distribution on a work is regarded as sufficiently uniform, one pair of opposed light emitters (e.g., the light emitters L1 and L5) may be used. In addition, if the illuminance distribution on a work is regarded as sufficiently uniform, one light emitter (e.g., the light emitter L1) may be used.

In the mode 3, the light emitters emitting blue light of all of the elevation angle groups are used to obtain a relatively high S/N ratio. In some embodiments, only the light emitters emitting blue light of the group L at the low angle may be used.

In the mode 3, illumination is performed with the light emitters emitting blue light. In some embodiments, illumination with the light emitters emitting red light may be performed based on the color of a work as described above.

In processing of images obtained in the mode 2, the ratio of representative values of pixel values is obtained. In some embodiments, any other evaluation value, such as the difference between representative values, may be obtained and used to detect a color defect.

As described above, the present embodiment provides the inspection apparatus advantageous in inspection of an object regarding color thereof.

### Second Embodiment

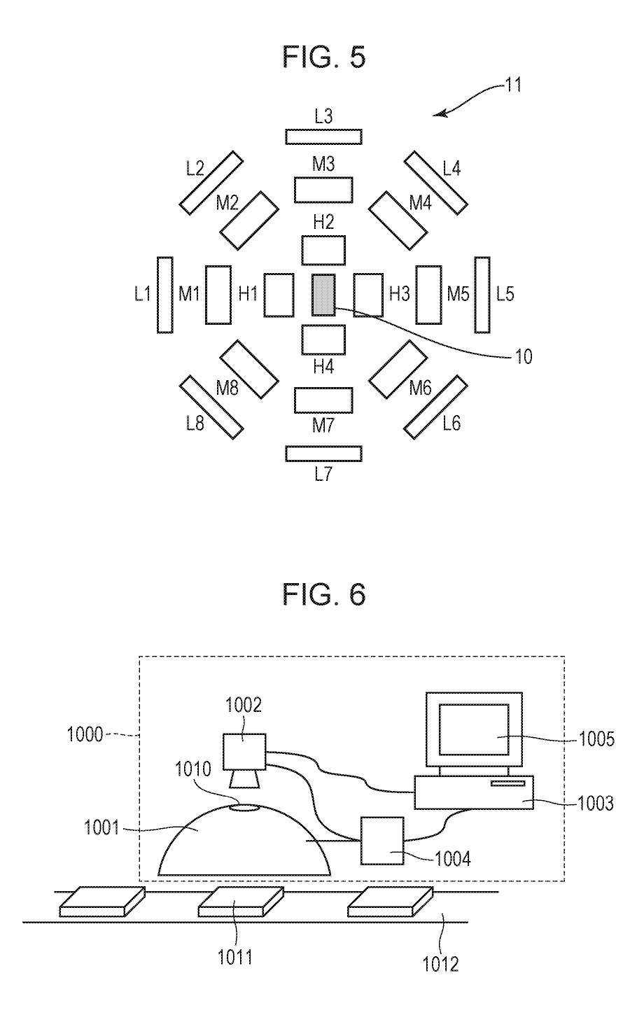

An inspection apparatus 1 according to a second embodiment differs from the inspection apparatus according to the first embodiment in that an illumination device in the second embodiment includes light emitters selectively emitting light of multiple colors (wavelengths). FIG. 5 illustrates an exemplary configuration of the illumination device included in the inspection apparatus 1 according to the second embodiment. Although each light emitter in the first embodiment is the LED emitting light of a single color, each light emitter in the second embodiment is an LED unit including a plurality of light emitting elements emitting light of multiple colors, for example, three colors of red, blue, and green. The LED unit can control each light emitting element to emit light. Specifically, the LED unit can emit single-color light of any of red, blue, and green colors and can also emit white light with all of the light emitting elements. The LED unit will be referred to as a multicolor LED unit hereinafter. Controlling the color of light emitted by the multicolor LED unit can detect a color defect of a work of any color. The use of light of the same colors as those in the first embodiment will be described as an example. For inspection of a work 10, a controller 18 can implement the following three modes (modes 1 to 3) for illumination and imaging.

Mode 1: the light emitters sequentially illuminate an object and imaging is performed in synchronism with the timing of illumination. In the present embodiment, each light emitter (multicolor LED unit) is caused to emit white light that provides a relatively high illuminance because this emission is effective in reducing exposure time.

Mode 2: imaging is performed under dark field illumination with light emitters L1, L3, L5, and L7 emitting blue light and imaging is performed under dark field illumination with light emitters L2, L4, L6, and L8 emitting red light. In the present embodiment, the light emitters (multicolor LED units) L1, L3, L5, and L7 are caused to emit blue light and the light emitters (multicolor LED units) L2, L4, L6, and L8 are caused to emit red light.

Mode 3: imaging is performed under illumination with light emitters L1, L3, L5, L7, M2, M4, M6, M8, H1, and H3 emitting blue light. In the present embodiment, the light emitters (multicolor LED units) L1, L3, L5, L7, M2, M4, M6, M8, H1, and H3 are caused to emit blue light. All of the light emitters (multicolor LED units) may be caused to emit blue light.

Since the light emitters in the present embodiment are the multicolor LED units capable of changing the wavelength of light to be emitted, the wavelength of light used in the modes 2 and 3 can be changed based on the color of a work or identification information identifying the work. A processor 15 can include a storage unit (e.g., an HDD 15c) that stores information indicating a correspondence relation between the identification information and the wavelength. A process for inspection (defect detection) based on images obtained by imaging under illumination in the modes can be identical to that in the first embodiment. Although the light emitters emitting blue light of all of the elevation angle groups are used to obtain a relatively high S/N ratio in the mode 3, only the light emitters L1, L3, L5, and L7 may be caused to emit blue light. In this case, an image obtained by imaging under illumination with blue light in the mode 2 can be used. Although each light emitter is the multicolor LED unit, any other arrangement may be used. Multicolor LED units are expensive compared to LEDs emitting light of a single color. In some embodiments, arrangement of multicolor LED units may be determined based on a range of colors of works to be inspected such that only the light emitters L1, L3, L5, and L7 in FIG. 5 or only the light emitters L1 to L8 are configured as multicolor LED units. In some embodiments, the light emitters (multicolor LED units) L1, L3, L5, L7, M2, M4, M6, M8, H1, and H3 or all of the light emitters may further be caused to emit red light in the mode 3. In this case, a defect, such as color irregularity, can be detected based on an image constituted by, as pixels thereof, the ratio of two corresponding pixel values of two obtained images. The ratio can be obtained as, for example, [a pixel value of a first image obtained with blue (first wavelength) light] divided by [a pixel value of a second image obtained with red (second wavelength) light]. The present embodiment provides the inspection apparatus advantageous in inspection of an object regarding color, for example, more colors or all colors.

### Third Embodiment

FIG. 6 illustrates an exemplary configuration of an inspection apparatus 1000. The inspection apparatus 1000 is to inspect a work 1011, serving as an object, for appearance. An inspection target is not limited to the appearance of an object. Objects may be inspected for characteristics, such as surface roughness, invisible to humans or difficult for humans to perceive. The inspection apparatus 1000 can inspect the works 1011 carried by the conveyor 1012, serving as a transport unit or transport device. Examples of the work 1011 include a metal member and a resin member to be used in industrial products. The surface of the work 1011 may have a defect, such as a linear flaw, irregularity (e.g., two-dimensional non-uniformity of optical reflection characteristics that depend on the surface roughness, components, or film thickness of a surface, a nonlinear or isotropic flaw, or a dent), or a light-absorbing foreign substance. The inspection apparatus 1000 identifies (detects) such a defect and processes the work 1011 (for example, classifies the work as either non-defective or defective. The conveyor 1012, serving as a transport unit, can be replaced by, for example, a robot or manual operation. In addition to or instead of the transport unit, a drive unit (e.g., a robot) for moving the inspection apparatus 1000 relative to the work 1011 may be used. In this case, at least one of the transport unit and the drive unit serves as a driver (driving apparatus) for performing relative movement between the inspection apparatus 1000 and the work 1011. The inspection apparatus 1000 and the driving apparatus constitute an inspection system. The driving apparatus may include one or more motors and/or belts for changing the relative position of apparatus 1000 and the work 1011 relative to each other.

The inspection apparatus 1000 may include an illumination device 1001, an imaging device 1002, a processor 1003, which may include a PC, a controller 1004, a display unit 1005, and an input unit (not illustrated). The illumination device 1001, the imaging device 1002, and the processor 1003 may be identical to those in the above-described first or second embodiment. The controller 1004 controls the illumination device 1001 and the imaging device 1002 based on an illumination and imaging pattern previously set by the processor 1003 such that these devices are in synchronism with each other. The illumination device 1001 has an opening 1010, through which the imaging device 1002 can image the work 1011, in top part of the illumination device 1001. The imaging device 1002 includes a camera body and an optical system for forming an image of the work 1011 on image pickup elements in the camera body. An image obtained by imaging is transferred or transmitted to the processor 1003. The processor 1003 is not limited to a general-purpose PC. The processor may be a special-purpose device. Furthermore, the processor 1003 may be integrated with the controller 1004. The processor 1003 performs processing for inspection of the work 1011, for example, a process of detecting a defect on the surface (appearance) of the work 1011, based on an image (data) transferred from the imaging device 1002. The processor (processing unit) 1003 can perform the processing based on acceptable conditions for (pixel) values of (image) data obtained by, for example, processing the image data from the imaging device 1002. The display unit 1005 displays an image and/or information indicating a processing result transmitted from the processor 1003. The input unit includes a keyboard and a mouse and transmits, for example, information input by the user, to the processor 1003.

The illumination device 1001 includes a plurality of LEDs (light emitters or light sources). The light emitters are not limited to LEDs. The controller 1004 can control the amount of light and the timing of light emission of each individual LED. The LEDs are arranged at, for example, three different elevation angles such that the work 1011 can be illuminated from a low elevation angle (low angle), a middle elevation angle (middle angle), and a high elevation angle (high angle). The LEDs are arranged in a circumferential direction of the illumination device 1001. With this configuration, the illumination device 1001 has a function of illuminating an object under any of different illumination conditions including bright field illumination and dark field illumination. Since the amount of light that contributes to imaging under bright field illumination may differ from that under dark field illumination, the amount of light under bright field illumination may also differ from that under dark field illumination. The LEDs previously set are sequentially turned on and the imaging device 1002 performs imaging in synchronism with the timing of turn-on, thus obtaining images of the work 1011 illuminated under various illumination conditions (including a combination of an elevation angle and an azimuth angle). Advantageously, various types of defects can be identified.

### Fourth Embodiment

The above-described inspection apparatus 1000 according to the third embodiment can be used in a method of manufacturing an article. The method may include inspecting an object using the above-described inspection apparatus 1000 or the inspection system and processing the inspected object based on an inspection result. The processing may include at least one of machining, cutting, transporting, assembling (building), inspecting, and sorting. The method of manufacturing an article according to the present embodiment is advantageous in at least one of performance, quality, productivity, and production cost of the article over related-art methods.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-091584 filed Apr. 28, 2016, which is hereby incorporated by reference herein in its entirety.

What is claimed is:

1. An inspection apparatus for performing inspection of an object, the apparatus comprising:
an illumination device configured to illuminate the object;
an imaging device configured to image the object illuminated by the illumination device; and
a processor configured to perform processing for the inspection based on an image obtained by the imaging device,
wherein the processor is configured to perform the processing based on a first image obtained by the imaging device under dark field illumination by the illumination device with light having a first wavelength and a second image obtained by the imaging device under dark field illumination by the illumination device with light having a second wavelength different from the first wavelength.

2. The apparatus according to claim 1, wherein the processor is configured to perform the processing for inspection of the object for color thereof based on the first image and the second image.

3. The apparatus according to claim 2, wherein the processor is configured to perform the processing based on a representative value of pixel values of the first image and a representative value of pixel values of the second image.

4. The apparatus according to claim 3, wherein the processor is configured to perform the processing based on a ratio or difference between the representative value of the first image and the representative value of the second image.

5. The apparatus according to claim 1, wherein the illumination device includes a light source configured to emit light having the first wavelength and a second light source configured to emit light having the second wavelength.

6. The apparatus according to claim 1,
wherein the illumination device has a function of changing the first wavelength and the second wavelength, and
wherein the processor is configured to determine the first wavelength and the second wavelength based on identification information identifying the object.

7. The apparatus according to claim 1,
wherein the illumination device includes a plurality of light sources configured to respectively illuminate the object from a plurality of azimuth angles at a specific elevation angle, and
wherein light sources configured to emit light having the first wavelength and light sources configured to emit light having the second wavelength are alternately arranged in the plurality of light sources.

8. The apparatus according to claim 1, wherein one of the first wavelength and the second wavelength is a wavelength corresponding to one of a color of the object and a complementary color thereof.

9. The apparatus according to claim 8, wherein the other of the first wavelength and the second wavelength is a wavelength corresponding to the other of the color of the object and the complementary color thereof.

10. The apparatus according to claim 1,
wherein the illumination device is configured to illuminate the object with light having the first wavelength and light having the second wavelength,
wherein the imaging device is configured to obtain, as the first image, an image corresponding to the first wavelength and obtain, as the second image, an image corresponding to the second wavelength.

11. An inspection apparatus for performing inspection of an object, the apparatus comprising:
an illumination device configured to illuminate the object;
an imaging device configured to image the object illuminated by the illumination device; and
a processor configured to perform processing for the inspection based on an image obtained by the imaging device,
wherein the processor is configured to perform processing for inspection of the object regarding color thereof based on an image obtained by the imaging device under illumination by the illumination device with light having a wavelength based on a color that the object is to have.

12. The apparatus according to claim 11, wherein the wavelength corresponds to one of the color and a complementary color thereof.

13. The apparatus according to claim 11, wherein the processor is configured to determine the wavelength based on identification information identifying the object.

14. The apparatus according to claim 13, wherein the processor includes a storage that stores information indicating a correspondence relation between the identification information and the wavelength.

15. The apparatus according to claim 11,
wherein the illumination device is configured to illuminate the object with light having, as the wavelength, a first wavelength and light having a second wavelength different from the first wavelength, and
wherein the imaging device is configured to obtain, as the image, an image corresponding to the first wavelength.

16. The apparatus according to claim 11, wherein the processor is configured to perform processing for inspection of the object for color irregularity thereof.

17. An inspection system comprising:
an inspection apparatus defined in claim 1; and
a driving apparatus configured to perform relative movement between the inspection apparatus and the object.

18. A method of manufacturing an article, the method comprising steps of:
performing inspection of an object using an inspection apparatus defined in claim 1; and
processing the object, of which the inspection has been performed, to manufacture the article.

19. A method of manufacturing an article, the method comprising steps of:
performing inspection of an object using an inspection apparatus defined in claim 11; and
processing the object, of which the inspection has been performed, to manufacture the article.
